(19) United States
(12) Patent Application Publication
(10) Pub. No.: US 2025/0259401 A1
(43) Pub. Date: Aug. 14, 2025

(54) CONTENT MANAGEMENT METHOD, CONTENT MANAGEMENT SYSTEM, METAVERSE, AND COMPUTER PROGRAMME PRODUCT

(71) Applicant: ETO GRUPPE TECHNOLOGIES GmbH, Stockach (DE)

(72) Inventors: Sharang Deepak PARNERKAR, Engen (DE); Tobias PLÖTZING, Bodman-Ludwigshafen (DE); Benjamin BÖNISCH, Bodman-Ludwigshafen (DE)

(21) Appl. No.: 18/859,249

(22) PCT Filed: Apr. 27, 2023
(86) PCT No.: PCT/EP2023/061110

§ 371 Date: Jan. 30, 2025

(30) Foreign Application Priority Data
May 2, 2022 (DE) 10 2022 110 762.0

(51) Int. Cl. G06T 19/00; H04L 9/00

(52) U.S. Cl. CPC G06T 19/006; H04L 9/50

(57) ABSTRACT

A content management method, in particular a location-based, preferably decentralized, content management method, is configured at least for managing digital contents within a metaverse linked to a distributed ledger technology (DLT), such as a blockchain or a tangle, wherein a virtual space defined by the metaverse is divided into a number of segments, in particular volume segments, arranged next to one another and/or above one another, and wherein digital contents are assigned to individual segments, wherein a decentralized autonomous organization (VolumeDAO) set up on the DLT is assigned to at least one of the segments.

### CROSS-REFERENCE TO RELATED APPLICATIONS

This application is a U.S. national stage application of international patent application PCT/EP2023/061110 filed on Apr. 27, 2023, which is based on and claims priority to German patent application DE 10 2022 110 762.0, filed on May 2, 2022, the contents of which are incorporated herein by reference.

### PRIOR ART

The invention relates to a content management method, a content management system, a metaverse and a computer program product.

In connection with popular projects such as Decentraland, a type of location-based decentralized content management method for managing digital contents within a metaverse linked to a blockchain (there: Ethereum Blockchain), wherein a virtual space defined by the metaverse is divided into a number of segments arranged next to one another, and wherein the digital contents can be assigned to individual segments, has already been proposed.

The object of the invention is in particular to provide a generic method having advantageous properties with regard to versatility, design freedom and/or user-friendliness. The object is achieved according to the invention.

### Advantages of the Invention

The invention is based on a, in particular computer-implemented, content management method (CMM), in particular a computer-implemented location-based, preferably decentralized, content management method, at least for managing digital contents (Content) within a metaverse linked to a distributed ledger technology (DLT), such as a blockchain or a tangle, wherein a virtual space defined by the metaverse is divided into a number of segments, in particular volume segments, arranged next to one another and/or above one another, and wherein digital contents are assigned to individual segments.

It is proposed that a decentralized autonomous organization (DAO, referred to below for short as VolumeDAO) set up on the DLT is assigned to at least one of the segments. As a result, properties with regard to versatility, design freedom and/or user-friendliness can advantageously be achieved. As a result, a high transparency of the CMM can advantageously be achieved, in particular by rules and governance of the CMM within each individual one of the segments being accessible to anyone and/or being comprehensible for anyone (unfalsifiable transparent audit trail). In addition, a high transparency can advantageously be achieved by the governance over individual segments being hard-coded in smart contracts unchangeably set up on the DLT. In addition, a high versatility and/or design freedom can advantageously be achieved by a (democratic) co-determination over processes in the individual segments being made possible for anyone, at any time. In this case, for example, an existing smart contract assigned to the VolumeDAO of a segment can advantageously be replaced by coordination among the participants of the VolumeDAO. Advantageously, no higher-level management and/or control structure is necessary for organizing the CMM. An influence spanning the CMM can advantageously be at least substantially prevented from the outside, for example by a manipulation or censorship of digital contents or the like. As a result, for example, a search function which can be influenced only to a very limited extent for finding digital contents can be made possible. In addition, a decentrality can advantageously be achieved, as a result of which a susceptibility to system failures can advantageously be reduced. A direct implementation of a content management method can advantageously be achieved, which is free of intermediaries, in particular in the remuneration of services and/or in the sharing of contents. As a result, a high efficiency, in particular cost efficiency and/or energy efficiency, can advantageously be achieved.

In a, in particular location-based, preferably decentralized, content management method, in particular digital contents are managed, that is to say provided, for example, which are linked, in particular virtually, at least to a coordinate in a metaverse and/or to a location coordinate. The content management method is preferably also configured for an addition of digital contents in a content management system (CMS). A digital content can be embodied as a digital image file, a digital video file, a digital sound file, a digital character string, a digital key, a digital computer program (app), a digital text or the like. In particular, the content management method is configured for providing the digital content in such a way that it can be played by a player of the user. In particular, the digital content is managed and/or provided via a smart contract which is preferably assigned to the VolumeDAO of the respective segment. In particular, an interaction of the user with the smart contract of the VolumeDAO takes place before the digital content is submitted, called up or played. In this case, a single smart contract of the respective VolumeDAO can organize/manage the provision of a plurality of digital contents within a segment or a separate, in particular individual, smart contract of the respective VolumeDAO can be assigned to each digital content or subsets of all digital contents within one of the segments. In particular, a result of the interaction with the smart contract of the VolumeDAO decides whether or not the digital content is provided for use by the user. The VolumeDAO and/or the smart contract is/are preferably set up on a DLT which is based on a directed acyclic graph architecture (DAG), such as IOTA™, for example. The VolumeDAO and/or the smart contract is/are advantageously set up on a DLT which is free or virtually free of transaction costs. The VolumeDAO and/or the smart contract is/are advantageously set up on a DLT which is at least substantially free of a limitation of a transaction throughput. Alternatively, however, other DLTs are also conceivable, e.g. smart contract-capable blockchains such as Ethereum, EOS, Stellar, Solana, Avalanche, Fantom, Cronos, Polygon, Algorand, Chainlink, Binance Smart Chain, etc. The smart contracts of the VolumeDAOs are advantageously publicly viewable and unchangeable by being set up on the DLT.

A “smart contract” is in particular to mean a contract which is set up on the DLT and comprises at least one, preferably a plurality of “if/then” conditions as preprogrammed functions which can be called. For this purpose, in particular “if” conditions are provided as input to the smart contract and the smart contract responds by an output/non-output of “then” results. In particular, the smart contract is embodied as a software code which is set up on the DLT. In particular, the smart contract is embodied to be unchangeable by being set up on the DLT. In particular, a DLT address in the DLT is assigned to the smart contract. In particular, the smart contract can be called by virtue of transactions being sent to the DLT address of the smart contract (“write”). In particular, an execution of the smart contract can require a payment of a fee which is added to the transactions which call the smart contract in the form of DLT tokens of the DLT, in particular governance tokens of the respective VolumeDAO. In particular, the smart contract is executed after more than one DLT node (“quorum”) of the DLT has been called up, wherein an output of the result takes place only if all members of the quorum arrive at the same result. After a DLT transaction which is triggered by the user has been received, the smart contract preferably executes the following steps: a) verifying the existence of the functions in the smart contract which are to be called up on the basis of the information received with the DLT transaction, possibly with a plausibility check of the parameters, b) verifying whether sufficient fees have been received in the form of DLT tokens, possibly surplus fees are sent back, c) preparing a transaction at one or more DLT addresses of the DLT network, in particular at least at the DLT address from which the smart contract has been called up, wherein the transaction comprises, for example, an access authorization to a digital content or a setting authorization of a digital content, etc., and d) executing the transaction. “Configured” is intended to be understood in particular to mean specifically programmed, designed and/or equipped. The fact that an object is configured for a specific function is intended to be understood in particular to mean that the object fulfills and/or executes this specific function in at least one application state and/or operating state.

A metaverse is in particular to mean a consistent and persistent digital/virtual space. In particular, the digital/virtual space of the metaverse arises as a result of a convergence of virtual and/or extended and physical reality. In particular, the virtual space of the metaverse is subdivided into the segments, wherein the segments can have different shapes, such as a cube shape, a shape of a hexagonal prism, a pyramid shape or another body shape with which a space can be filled without gaps. The segments can be identically shaped and identically large, but it is conceivable for individual segments to be able to be branched further into subsegments and/or for the segments to be at least partially of different size and/or different shape. This could be determined, for example, by a smart contract of a VolumeDAO which would then be superordinate over sub-VolumeDAOs of individual subsegments. As a result, it is advantageously possible to achieve an arbitrarily deep interleaving of increasingly smaller metaverses. Alternatively or additionally, however, it is also conceivable for VolumeDAOs of individual segments to be connected and/or linked to one another (e.g. via corresponding common smart contracts) by decisions made in the VolumeDAOs. In this way, individual sub-metaverses of the metaverse can be merged with one another. In particular, a digital content assigned, for example, to a particularly large object, such as, for example, a building, can also be assigned to a plurality of volume segments, and thus in particular to a plurality of VolumeDAOs. Advantageously, the segments are free of overlap with one another. Advantageously, the segments cover at least one region of interest, e.g. a region of the globe which is accessible to people, without gaps.

A “decentralized autonomous organization (DAO)” is in particular a technical organizational structure whose governance is anchored in various smart contracts which are set up on a DLT and which are executed when specific defined prerequisites are fulfilled. The governance in the DAO is in particular substantially different from a CEO who makes decisions. The governance in the DAO requires in particular a democratic consensus which is hard-coded in the smart contract(s) of the DAO. In principle, any VolumeDAO can also be provided with a fixed value system, for example a higher-level DAO. This is in particular a higher-level set of rules which applies to all segments/VolumeDAOs of the CMS/CMM. It is possible here that not all rules are applicable/apply to all segments/VolumeDAOs, but no segment/VolumeDAO can violate these rules. By way of example, such a higher-level rule could read: “Hate speech is not allowed”. This rule would then apply everywhere. By way of example, such a higher-level rule could read: “Advertising is not allowed in public buildings or churches”. This rule would then apply to segments within churches, but not to segments within shopping malls. Advantageously, the rules of the fixed value system are programmable. If, for example, a new VolumeDAO is created, e.g. because content is added, the VolumeDAO pulls the corresponding set of rules from the CMS/CMM or the higher-level DAO on the basis of its geographical position. Alternatively or additionally, it is conceivable that the users participating in the respective volume (owners of governance tokens of the respective VolumeDAO) determine the determination of the nature of the real space in a certain segment (is it a school or a church, for example?) via votings within the VolumeDAO and thus, in particular, also determine the basic set of rules of the VolumeDAO. In order to avoid misuse, it is conceivable that the CMS/CMM or the higher-level DAO has a veto right for each of the VolumeDAOs, which veto right can be used, for example, only if there is a minimum number of complaints via a reporting button. Auditors of the CMS/CMM or of the higher-level DAO can also be used, which auditors travel to a disputed location and check the circumstances on site.

Furthermore, it is proposed that the CMM comprises the method steps: a1) receiving a new digital content uploaded into/from one of the segments, in particular by the DLT or a2) receiving information that a digital content has been uploaded into/from a segment and b) checking whether a decentralized autonomous organization (VolumeDAO) assigned to this segment and set up on the DLT already exists and c) creating a new VolumeDAO for the segment within the DLT, in the case that no VolumeDAO assigned to the segment already exists. As a result, a simple, efficient and/or user-friendly implementation of the CMM can advantageously be achieved. In particular, when creating the new VolumeDAO, a standard smart contract defining the new VolumeDAO or a bundle of interacting standard smart contracts which define the new VolumeDAO can be automatically assigned to said new VolumeDAO. Alternatively or additionally, when creating the new VolumeDAO, a selection of prefabricated initial smart contracts defining the new VolumeDAO can be provided to the user who has uploaded the first digital content in the segment, wherein the smart contract(s) determined by the user selection are then assigned to the new VolumeDAO and define the new VolumeDAO. Alternatively or additionally, when creating the new VolumeDAO, a request to provide a custom smart contract defining the new VolumeDAO can be displayed to the user who has uploaded the first digital content in the segment, whereupon the user can provide one or more custom smart contracts which is/are then assigned to the new VolumeDAO and which defines/define the new VolumeDAO. In particular, the prepared or automatically provided standard smart contracts and/or initial smart contracts can also be embodied to be modifiable and/or adaptable when creating the VolumeDAO by the user who uploads the first digital content in the segment.

If the virtual space is superimposed on the real existing space and in particular at least spans the globe, a metaverse can advantageously be provided with a reference to the real world. A particularly comprehensive and large amount of information can advantageously be achieved as a result. A location-based CMM can advantageously be realized as a result. A digital content, for example information, can advantageously be linked to a spatial component. The digital contents can advantageously be spatially positioned in three dimensions. A decentrally organized three-dimensional knowledge space can advantageously be created which can be filled in particular with free knowledge created by anyone. A search by spatial information can advantageously be refined and/or improved in this case. For example, the three-dimensional knowledge space comprising the spatial information could be searchable in a more targeted manner by search engines or by intelligent AI search bots of the Web 4.0, since information is linked to spaces. The virtual space can also lie and/or be defined at least partially within the globe. In particular, the CMS/CMM comprises a bijective mapping at least between a part, in particular a virtually visitable part, of the real existing space and the virtual space. In particular, the virtual space and the real existing space are mapped bijectively to one another at least in parts of the totality of the real existing space. In particular, a bijective mapping between volume elements of the physical world/material universe and the segments of the virtual world/virtual space exists, preferably limited to parts of the totality of the real existing space, e.g. limited to “interesting” parts or virtually visitable parts of the real existing space. By way of example, the three-dimensional addition space could be composed/constructed as follows. Firstly, the globe plus a height of approximately 10 km is inserted into a cube. This cube is then subdivided e.g. into 1 m×1 m×1 m subcubes (segments). In the case of a diameter of the globe of approximately 12,756 km, the cube would then have an edge length of approximately 12,800 km and would have approximately 12,800×12,800×12,800×1,000=2,097,152,000,000,000 subcubes. Subcubes which lie at unreachable points below the earth surface, that is to say e.g. subcubes within a globe radius minus a depth of 10 km (in order to also be able to comprise underwater objects, cavities etc.), then remained unconsidered and a biunique DLT address is then assigned to all other subcubes. As a result, approximately 2,097,152,000,000,000−12,700×12,700×12,700×1,000=48,769,000,000,000 subcubes with DLT addresses would be obtained. In this example, these subcubes with DLT addresses then form the individual segments, in particular volume segments. In this example, the totality of all subcubes with DLT addresses then forms the three-dimensional addition space. Of course, three-dimensional addition spaces are also conceivable which are more limited (e.g. limited only to one building) or outside the earth (e.g. spanning the moon, etc.). Of course, finer or coarser resolutions of the three-dimensional addition space into segments, in particular volume segments, than the 1 cubic meter cubes are also conceivable. By way of example, starting from the earth center, cuboid structures which become increasingly larger and have approximately 1 m³ spatial volume at the earth surface, but become increasingly larger with increasing distance from the earth, could be generated by means of imaginary laser beams. The segments, in particular volume segments, of the three-dimensional addition space advantageously form a clean spatial search grid for search engines and/or AI search bots.

In addition, it is proposed that each of the digital contents is linked to at least one smart contract which belongs to the VolumeDAO associated with the segment into/from which the digital content was originally uploaded. In this case, the digital content can also be provided to further users via a smart contract of this VolumeDAO. As a result, a high user-friendliness can advantageously be achieved, in particular by a particularly high transparency with regard to the origin of contents and/or with regard to remuneration streams being able to be achieved. A direct implementation of a content management method can advantageously be achieved, which is free of intermediaries, in particular in the remuneration of services and/or in the sharing of contents.

In addition, it is proposed that upon receiving the uploaded digital content an assignment of the digital content to the respective segment in the virtual space is effected by a localization of the user initiating the upload and/or interface device in the real existing space superimposed by the virtual space. A location-based CMM can advantageously be realized as a result. A digital content, for example information, can advantageously be linked to a spatial component. The determination of the location of the user can be effected by means of a locating function of a device of the user, for example of an interface device of the user, which allows an upload and/or playing of the digital contents. For example, a global locating using navigation satellite systems (GNSS), such as GPS, etc., or a local locating using locating methods independent of navigation satellite systems, such as a local triangulation with anchor stations, for example via ultra-wideband (UWB) signals, or the like or a local time-of-flight measurement, etc., are conceivable. Alternatively, it is conceivable for a user to prove his/her presence in a particular segment by reading in a tag, for example a QR code, a data matrix code or a barcode, which is positioned at the associated location and connected to the segment. It is conceivable for a certain different reputation level to be assigned to the NFTs (for example FollowerNFT or CreatorNFT) assigned to this user as a function of a strength of proof of the localization, for example on the basis of the localization method used by the respective user. For example, a particularly proof-of-proof and/or forgery-proof distance measurement to one of the anchor stations can be implemented by means of IEEE802.15.4z (UWB) and cryptography, as a result of which a highest possible reputation level for localization data can advantageously be achieved. By way of example, a lower reputation level can be assigned to a (spoofable) localization by means of GNSS. It is conceivable for a reputation level to be able to be increased/improved, for example by means of certain activities of the user. By way of example, a number of visits to a segment, a frequency of visits to a segment, a number or frequency of visits to adjacent or (thematically or locally) related segments can lead to an increase/improvement in the reputation level. By way of example, a new NFT for a person in a segment which is assigned to a church can already be assigned a higher reputation level if this person has already demonstrably visited a large number of churches and/or already demonstrably possesses a larger number of NFTs which are assigned to other “church segments”. The digital contents can be provided to further users of the CMM via the method described in the German patent application with the application number 10 2022 107 027.1, the description of which is hereby incorporated fully into the present patent application.

Furthermore, it is proposed that in response to the upload of the digital content from the segment a Creator Non-Fungible Token (CreatorNFT) is generated within the DLT. As a result, a secure, unfalsifiable and/or easily traceable assignment of digital contents can advantageously be made possible. In particular, the CreatorNFT is linked to the respective digital content which has effected its generation. In particular, a user can prove a right of ownership and/or disposition over the digital content linked thereto by proving the possession of the CreatorNFT. It is conceivable for additional information/metadata, such as for example a time stamp, a usage fee, a license claim, etc., to be appended to the CreatorNFT. By appending the tags such as the time stamp in the submitting of the content, a time-based content search in a segment can advantageously be made possible, in particular in addition to a location-based content search.

In addition, it is proposed that the digital content is linked to the CreatorNFT. As a result, a secure, unfalsifiable and/or easily traceable assignment of digital contents can advantageously be made possible. A non-fungible token (NFT), sometimes also called non-exchangeable token, is intended to be understood in particular to mean a digitized form of a data record/asset which is preferably set up on a DLT, such as a blockchain or a tangle or the like, and which is embodied in particular so as not to be exchangeable one-to-one, not divisible and unique. NFTs can be distributable and/or dispatchable within the VolumeDAO and/or within the DLT. In public DLTs, the NFTs set up thereon and preferably transactions associated with the NFT can be viewed by anyone. An NFT can be linked in particular to at least one physical or digital object, such as, for example, a digital content. In particular, the CreatorNFT created in response to the upload of the digital content from the segment is linked at least to the uploaded digital content. For this purpose, the CreatorNFT comprises the digital content directly or in the form of a hash value which is created on the basis of the digital content, or the like. As soon as the creation of the CreatorNFT has been confirmed by the consensus protocol of the respective DLT, the assignment of the digital content to the CreatorNFT is unchangeable and permanently (up to a possible dissolution or destruction by an owner of the CreatorNFT) recorded in the DLT. The creation of an NFT, in particular of an NFT connected to an object/digital content, is often also referred to as “minting” of the NFT. In particular, the CreatorNFT is generated by the smart contract of the VolumeDAO or of the higher-level CMM. A destruction of an NFT or an impossibilization of an ownership of the NFT for anyone is often also referred to as “burning” of the NFT. A triggering of an NFT, i.e. a dissolution of the relationship between the NFT and the object assigned to it, is often also referred to as “redeeming” of the NFT. In particular, the CreatorNFT can be created using a smallest possible unit of a DLT token. The DLT token forms an underlying asset. For some applications, the underlying asset can also be increased, for example can contain the actual value of the digital content at the time of the creation, etc.

CreatorNFTs are preferably assigned to at least one, preferably precisely one, owner address within the DLT. Alternatively, however, it is also conceivable for a CreatorNFT to be linked to more than one DLT owner address or for a plurality of users to have access to an individual DLT owner address and thus to the CreatorNFT. This owner address assigned to the CreatorNFT can be alterable, for example, by sending, acting or exchanging the CreatorNFT. Alternatively, however, the CreatorNFT can also be designed to be non-transmittable. The DLT is preferably embodied as a decentralized DLT. Alternatively, the DLT can also be embodied to be only partially decentralized (distributed over a few nodes) or centralized. The DLT is preferably embodied as a publicly viewable DLT. Alternatively, it is conceivable for the DLT to have at least one access restriction. The NFT is preferably publicly viewable via the DLT. The owner address assigned to the NFT is preferably publicly viewable via the DLT. The assignment of the NFT to the owner address is preferably publicly viewable via the DLT.

If the CreatorNFT forms a Governance Token of the VolumeDAO, and in particular if the created CreatorNFT is sent to a DLT address of the DLT which is assigned to a user who has uploaded the respective digital content, local self-management of the digital contents, in particular by users connected to the respective segment, can advantageously be made possible. A Governance Token is in particular a token of the DLT which gives its owner (the user with access to the DLT address to which the Governance Token is assigned) the possibility of influencing decisions which relate to rules and/or an organization of the DAO (the VolumeDAO of the respective segment in which the CreatorNFT was created), in particular a core protocol of the DAO and changes to governance parameters of the DAO. In particular, the Governance Tokens lend a relative voting power within the respective VolumeDAO which is preferably dependent on a proportion of Governance Tokens which are in the possession of a user in a totality (possibly expandable by a minting of new Governance Tokens during an upload of further digital contents) of all Governance Tokens of the respective VolumeDAO. For example, each user receives a vote in the VolumeDAO per Governance Token which is under his control. In addition, it is conceivable that each owner of a minimum number of Governance Tokens receives a right to propose particular topics for coordination within the VolumeDAO. It is conceivable for a voting power of an NFT (CreatorNFT/FollowerNFT) within the VolumeDAO to be directly dependent on the reputation level which was assigned to the respective NFT during the creation thereof.

In addition, it is proposed that for each further digital content uploaded within the segment a further CreatorNFT is generated within the DLT, which in particular is linked to the respective further digital content, and which in particular likewise forms a Governance Token of the VolumeDAO. As a result, a self-managed ecosystem of content management systems with segment-specific regulations can advantageously be created. A high flexibility and/or user-friendliness can advantageously be achieved. It is conceivable for a total number of Governance Tokens per VolumeDAO to be limited or unlimited or for a limitation of the total number of Governance Tokens to be definable by coordination within the respective VolumeDAO itself.

If the segments, in particular the digital contents assigned to the segments, in particular the CreatorNFTs comprising the digital contents, can be searched remotely, a three-dimensional knowledge space can advantageously be created which can be searched in a more targeted manner, for example, by search engines or by intelligent AI search bots of the Web 4.0. By way of example, the CreatorNFTs can be searchable similarly to a DLT-based NFT marketplace search. As a result, an independent, manipulation-secure and/or censorship-free search option within the metaverse can be made possible. That digital contents can be searched “remotely” is intended to be understood in particular to mean that the digital contents and/or their assigned CreatorNFTs can be searched from outside the respective segments, in particular by machines and/or users who are located in the real existing space outside the respective segments.

Furthermore, it is proposed that a user, in particular a further user, is assigned as a follower to at least one of the segments, in particular by the method steps a) receiving a registration of a new follower for one of the segments, for example by a superordinate smart contract of the metaverse, b) checking whether a VolumeDAO assigned to the segment and set up on the DLT already exists and c) creating a new VolumeDAO for the segment within the DLT, in the case that no VolumeDAO assigned to the segment already exists. As a result, a simple, efficient and/or user-friendly implementation of the CMM can advantageously be achieved. In this case, the creation of the VolumeDAO can proceed analogously to the above-described creation of a VolumeDAO during a first upload of a digital content. In particular, no upload/provision of a digital content is necessary for the registration as a follower. In particular, the registration can take place as a follower from outside the segment. In particular, in order to check whether a VolumeDAO assigned to one of the segments and set up on the DLT already exists, the DLT address assigned to the segment can be searched for smart contracts linked to it. If one or more smart contracts which are assigned to the DLT address assigned to the segment already exist, it is then possible, for example by analysis of the publicly viewable code of the smart contracts, to determine whether these smart contracts are associated with a DAO, in particular a VolumeDAO, or whether they fulfill other tasks.

Furthermore, it is proposed that upon a detection of a stay of a follower of the segment at a location in the real existing space, which is superimposed on this segment in the virtual space, a Follower Non-Fungible Token (FollowerNFT) is generated within the DLT, which is advantageously sent to a DLT address of the DLT which is assigned to the follower who has proved his stay within the segment and/or which advantageously forms an, in particular further, Governance Token of the VolumeDAO. As a result, a particularly advantageous local self-management of the digital contents, in particular by users (contributer and follower) connected to the respective segment, can be made possible. For example, the contributers and the followers can decide which types of digital contents can be uploaded and/or consumed in a segment. A self-managed ecosystem of content management systems (CMS) with segment-specific regulations can advantageously be created. A high flexibility and/or user-friendliness can advantageously be achieved as a result. A CMM/CMS which is independent of an overall control entity, in particular a small-part CMM/CMS, can advantageously be created which is in particular particularly resistant to censorship or other external influences. In particular, the FollowerNFT Governance Tokens, in particular with regard to a voting power, can be equivalent to the CreatorNFT Governance Tokens. Alternatively, the participation rights connected to the respective Governance Tokens can differ in the design of the segment/of the VolumeDAO. By way of example, the CreatorNFT Governance Token could be assigned a different voting power, in particular a higher voting power, than the FollowerNFT Governance Token. By way of example, the owners of CreatorNFTs could be assigned powers within the respective VolumeDAO which owners of FollowerNFTs do not possess (for example a right of proposal for coordination within the VolumeDAO). In addition, it is also conceivable for each segment (in addition to undeclarable content uploaded by users) to comprise editable information, for example similarly to a localized Wikipedia. This editable information can then for example be changed, deleted and/or created only by users who possess at least one Governance Token of the VolumeDAO of the segment. Deletions, creations and/or changes to the editable information can be brought to coordination in the VolumeDAO.

In addition, it is proposed that a, in particular higher-level, VolumeNon-Fungible Token (VolumeNFT) of the DLT is assigned to each of the segments of the virtual space forming the metaverse, which comprises spatial (real) coordinates which define the respective segment and link the respective segment to the real space. As a result, a main metaverse which corresponds one-to-one to the geosphere of the earth can advantageously be made available. This main metaverse contains smaller metaverses in the form of the segments with the VolumeDAOs. The arrangements of these smaller metaverses within the main metaverse are then advantageously irreversibly connected to the physical level. A location-based content management system can advantageously be obtained as a result. A comprehensive but lightning-fast search engine can now advantageously be provided which makes it possible to search for digital contents which are indexed on NFTs, since each of the metaverses, each of the segments and/or each of the VolumeDAOs is permanently connected to a real location on the earth via the VolumeNFT. The VolumeNFTs can be assigned DLT addresses which are under the control of entities. By way of example, the VolumeNFTs can be in the possession of an organization which has set up the CMS. By way of example, the VolumeNFTs can be acquired by third parties. In this case, it is conceivable that a proof of a possession or an authorization of the real existing space linked to the respective segment is taken into account in the transmission of the possession to the associated VolumeNFT. Alternatively, the VolumeNFTs could be assigned to a Burn address of the DLT to which no one has access. In particular, the VolumeNFT comprises the spatial real coordinates directly and publicly viewable, or as a hash or the like or in encrypted form.

That the VolumeNFT is embodied to be “superordinate” is intended to be understood in particular to mean that the VolumeNFT originates from a superordinate smart contract of the entire metaverse and in particular not from one of the smart contracts of the individual VolumeDAOs formed in the segments. In particular, a bijective mapping exists between physical locations and VolumeNFTs.

If the VolumeNFT does not form a Governance Token of the VolumeDAO, a high decentrality and independence of the CMS/CMM can advantageously be achieved. As a result, the owner of the VolumeNFT advantageously has no influence on the content and the processes within the associated segment unless he himself actively participates in the associated VolumeDAO by virtue of possessing CreatorNFTs and/or FollowerNFTs of the VolumeDAO which he can obtain in particular exclusively via the above-described regular path. A transfer of ownership of the VolumeNFT advantageously has no influence on the VolumeDAO or the digital contents managed by the VolumeDAO. An influence from outside on local processes is advantageously made more difficult as a result, in particular since only those entities which have actually been demonstrably on site at least once are assigned Governance Tokens for the VolumeDAO. By way of example, a foreign organization which wishes to influence a local VolumeDAO in the United States would have to send a large number of persons to the location of the segment and/or acquire a large number of already existing CreatorNFTs and/or FollowerNFTs of the local VolumeDAO from, in particular predominantly locally rooted, persons in order to possess enough voting power for a substantial influence on the VolumeDAO. The owners of the VolumeNFTs could thus in particular not coordinate via proposals in the VolumeDAO, but they could be the only ones which can submit new proposals for changing the governance of the associated VolumeDAO via which it is then possible for the owners of the FollowerNFTs and/or of the CreatorNFTs to coordinate within the VolumeDAO.

Alternatively, however, it is also conceivable for the VolumeNFT to form a Governance Token of the VolumeDAO. In addition, it is alternatively conceivable that, in the event of a destruction (“burning”) of a VolumeNFT associated with a segment, a new VolumeNFT for the segment or a plurality of new VolumeNFTs for respective subvolumes of the segment are generated, in particular automatically. A high flexibility can advantageously be achieved as a result. In addition, it is conceivable that, in the event of a withdrawal of a provision of a digital content from a segment, the associated CreatorNFT is destroyed or loses its voting right in the VolumeDAO of the segment.

Furthermore, it is proposed that the respective Governance Tokens and/or the VolumeNFT can be transferred, in particular freely, between DLT addresses of the DLT. As a result, properties with regard to versatility, design freedom and/or user-friendliness can advantageously be achieved. In particular, the Governance Tokens and/or the VolumeNFT can be traded, preferably freely, on NFT marketplaces. That the Governance Tokens and/or the VolumeNFT can be transferred or traded “freely” is intended to be understood in particular to mean that the Governance Tokens and/or the VolumeNFT can also be transferred to entities which are located outside the segments and/or which have never visited the segment in the real existing space.

In addition, it is conceivable for further NFTs to exist which can be assigned to the respective VolumeDAOs and which can or cannot fulfill the function of a Governance Token of the VolumeDAO. By way of example, there could be a MarketingNFT which regulates an authorization for switching marketing and/or advertising within a segment. This MarketingNFT would then have no Governance Token function, for example. Like all NFTs, the MarketingNFT can also be destroyed (burned), dissolved (redeemed) or transferred, as a result of which the underlying advertising rights in the respective segment are manipulated. Furthermore, there could be, for example, an InsuranceNFT via which an insurer can offer a liability insurance for a user who uploads digital contents. The InsuranceNFT could then be linked to particular digital contents and to an insurance policy. The insurer could then, for example (via a smart contract), receive a fee, e.g. 1%, from proceeds obtained by means of the digital content and, in return, assumes liability damages which can arise, for example, as a result of possible copyright infringements. As a result, a user participating in the VolumeDAO would advantageously have the possibility of selecting this option in a particularly simple manner, and the insurer would not have to check every single digital content since he would likewise benefit from the Community Guidelines which are anchored in the VolumeDAO and/or the higher-level DAO. The insurer would thus have the possibility of excluding liability for infringements of the basic values in the VolumeDAO and/or the higher-level DAO and assumes only the risks which remain. The InsuranceNFT does not form a Governance Token of the VolumeDAO.

Furthermore, a content management system (CMS), in particular a location-based, preferably decentralized, content management system, at least for managing digital contents (Content) within the metaverse linked to the distributed ledger technology (DLT), such as a blockchain or a tangle, in particular by means of the content management method, is proposed, wherein the virtual space defined by the metaverse is divided into a number of segments, in particular volume segments, arranged next to one another and/or above one another, and wherein digital contents are assigned to individual segments, and wherein a decentralized autonomous organization (VolumeDAO) set up on the DLT is assigned to at least one of the segments. As a result, properties with regard to versatility, design freedom and/or user-friendliness can advantageously be achieved. In particular, the CMS comprises at least one interface device which can be embodied as an electronic (Computer) device and which is preferably equipped with software, in particular preinstalled software, which is configured at least for executing the above-described CMM, in particular for an upload and/or consumption of digital contents and/or for participation in a VolumeDAO. In particular, the interface device is configured for communication with the DLT. The interface device can be embodied as a smartphone, as a tablet, as a notebook or the like. In particular, the interface device is embodied in such a way that it is extensively described in the German patent application with the application number 10 2021 112 613.4, which is hereby incorporated fully into the present patent application.

In particular, the interface device forms a localization device. In particular, the interface device is configured for a geographical localization of spatially positioned digital contents. Upon detection of a digital content in a region of a current location of the user of the interface device, this is then proposed and/or offered to the user for retrieval. The determination of the digital contents virtually arranged in the region of the location of the user can be effected via a comparison of the location/location coordinate currently determined for the user with the respective location coordinates which are assigned to the digital contents within the CMS. The region can be defined variably in this case. Meaningful region sizes can be formed, for example, by circles with diameters of between 0.5 m and 10 m (for example 0.5 m, 1 m, 1.5 m, 2 m, 2.5 m, 3 m, 4 m, 5 m, 6 m, 7 m, 8 m, 9 m, 10 m) around the currently determined location of the user. For certain applications, such as e.g. city tours, even far larger regions of a plurality of 10 m or even 100 m are conceivable. In particular, the region could be formed by the segment in which the user is currently located or by a defined number of regions in the area around the current location of the user. If one or more digital contents are now found in the defined region, these can be displayed to the user for selection, e.g. in a dropdown menu of data glasses. Digital contents which are displayed to the user for selection can be played by the user at the location at which the user is currently located. In this case, it is conceivable that the digital contents are removed again from the selection made available to the user if the user moves away from the location coordinate of the digital content, in particular if the digital content is no longer located in the location-changed region of the location of the user. Alternatively, it is conceivable for the user to “collect” all digital contents which were once located in the region of the location of the user and to then provide these to him for a later, possibly temporally limited, retrieval. In addition, it is conceivable for the digital contents to be ranked or to be displayed in a ranked manner. By way of example, the digital contents can be displayed sorted as a function of user ratings, e.g. a number of “likes” or a number of points awarded by users. In particular, higher-ranked digital contents could be displayed preferably or enlarged or specifically marked.

In addition, it is proposed that the localization device is configured for determining an instantaneous position of the user via a communication with locally located anchor stations, wherein at least one of the anchor stations is configured to locally store digital contents with local reference, in particular redundantly, and to provide them to the locally present user for retrieval, for example by UWB, Bluetooth, WLAN or the like. As a result, a particularly efficient CMS can advantageously be created in which transmission bandwidth, indexing effort in the search engine, memory requirement and/or in particular energy requirement can be minimized, preferably without reducing user comfort on site. In addition, this can advantageously limit an energy requirement which otherwise increases greatly with the data volume in centralized structures. In particular, the digital contents are also stored redundantly in the DLT or remotely from the anchor station in order to keep a risk of data loss low.

In addition, a metaverse, in particular of the content management system, is proposed which comprises a plurality of sub-metaverses which are each formed by a segment of the virtual space defining the metaverse and which are each managed decentrally by one of the VolumeDAOs set up on the distributed ledger technology (DLT), such as a blockchain or a tangle. A decentrally organized three-dimensional knowledge space superimposed on the real world can advantageously be created which can be filled in particular with free knowledge created by anyone.

In addition, a computer program product comprising commands which, when the program is executed by a computer, for example a smartphone, a tablet, a notebook or an interface device, cause the latter to carry out the steps of the content management method is proposed. In particular, the computer has at least one processor and a memory with the program stored in the memory unit.

The content management method according to the invention, the content management system according to the invention, the metaverse according to the invention and the computer program product according to the invention are not intended to be restricted here to the application and embodiment described above. In particular, the content management method according to the invention, the content management system according to the invention, the metaverse according to the invention and the computer program product according to the invention can have a number of individual elements, components and units differing from a number mentioned herein in order to fulfill a functionality described herein.

### DRAWINGS

Further advantages result from the following description of the drawings. An exemplary embodiment of the invention is illustrated in the drawings. The drawings, the description and the claims contain numerous features in combination. The person skilled in the art will expediently also consider the features individually and combine them to form meaningful further combinations.

In the drawings:

FIG. 1 schematically shows a metaverse of a content management system (CMS) according to the invention,

FIG. 2 shows a simplified schematic diagram of the CMS,

FIG. 3 shows a part of a schematic flow diagram of a content management method (CMM) and

FIG. 4 shows a further part of the flow diagram of the CMM.

### DESCRIPTION OF THE EXEMPLARY EMBODIMENTS

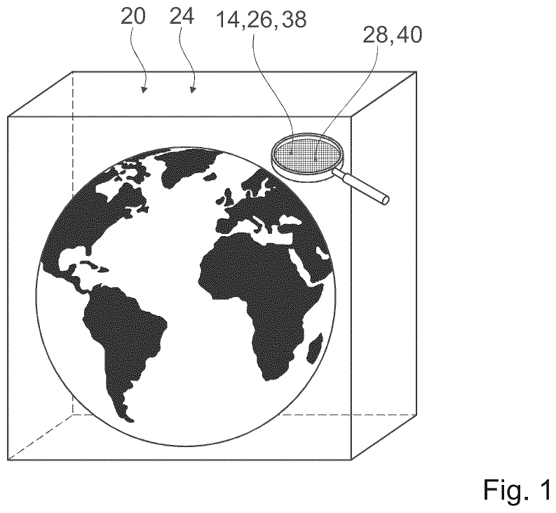

FIG. 1 shows a metaverse 20 of a content management system (CMS 48) according to the invention. The metaverse 20 defines a virtual space 24. The virtual space 24 is superimposed on the real existing space. The virtual space 24 is embodied to span the globe. The virtual space 24 is divided into a plurality of segments 26, 28 arranged next to one another and above one another. The segments 26, 28 respectively form volume segments, e.g. cubes. The segments 26, 28 are all of identical size and identical shape. A plurality of digital contents 10 can respectively be assigned to the segments 26, 28. The segments 26, 28 can be searched remotely. The digital contents 10 assigned to the segments 26, 28 can be searched remotely. The metaverse 20 comprises a plurality of sub-metaverses 38, 40. The sub-metaverses 38, 40 are each formed by a segment 26, 28 of the entire virtual space 24 defining the metaverse 20. Each of the sub-metaverses 38, 40 is respectively managed decentrally and independently with respect to other sub-metaverses 38, 40 by a decentralized autonomous organization (VolumeDAO 14) set up on a distributed ledger technology (DLT 16), such as a blockchain or a tangle. A higher-level VolumeNon-Fungible Token (VolumeNFT 36) of the DLT 16 is assigned to each of the segments 26, 28 of the virtual space 24 forming the metaverse 20. The VolumeNFT 36 comprises spatial (real) coordinates which define the respective segment 26, 28 and link the respective segment 26, 28 to the real existing space. In this case, the VolumeNFT 36 does not form a Governance Token of the VolumeDAO 14. The VolumeNFT 36 can be transferred freely.

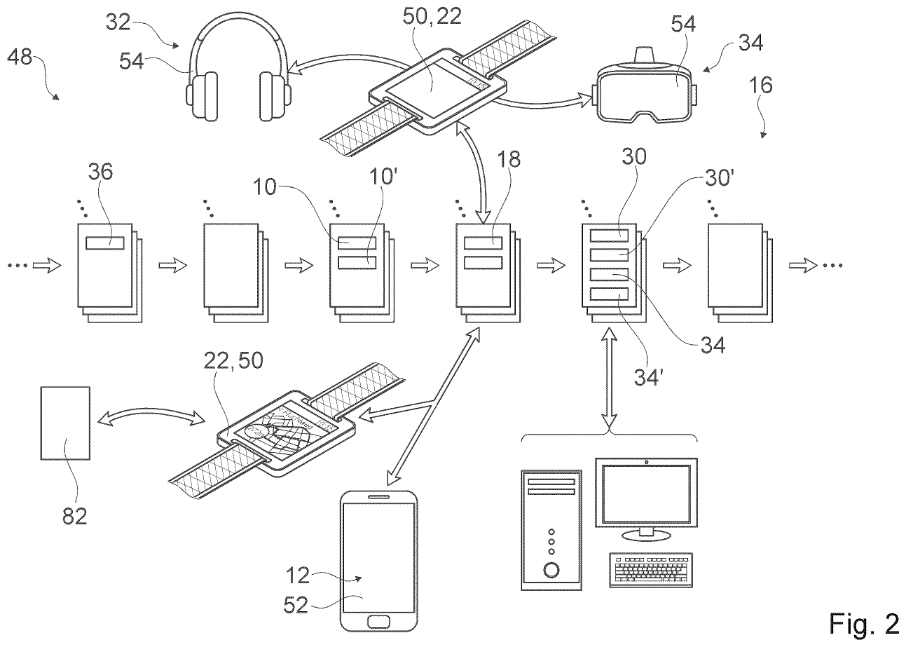

FIG. 2 shows a very simplified schematic diagram of the CMS 48. The CMS 48 is configured for managing digital contents 10. The CMS 48 is configured for managing digital contents 10 within the metaverse 20. The CMS 48 is configured for managing digital contents 10 within the sub-metaverses 38, 40. The CMS 48 is configured for executing a computer program product which implements a content management method (CMM) described below. The CMS 48 is configured for adding and outputting the digital contents 10 to a user 12. The CMS 48 is embodied as a location-based CMS 48. The digital contents 10 of the location-based CMS 48 are respectively linked to location coordinates. The CMS 48 is embodied to be decentralized. The digital contents 10 of the decentralized CMS 48 are managed decentrally via the DLT 16. The digital contents 10 of the decentralized CMS 48 are added and output decentrally via the DLT 16. The DLT 16 is embodied as a decentralized DLT 16. The DLT 16 is embodied as a public DLT 16. Alternatively, the DLT 16 can also be embodied to be private, at least partially centralized and/or non-public. The DLT 16 is preferably embodied as an IOTA™ tangle. In FIG. 2, however, the DLT 16 is sketched by way of example as a blockchain. The digital contents 10 of the decentralized CMS 48 can be stored decentrally, for example on the DLT 16, such as a blockchain or a tangle. Alternatively, however, the digital contents 10 can also be stored centrally on a server or on a cloud and only the management can be carried out decentrally. The CMS 48 comprises a smart contract 18. The smart contract 18 is set up on the DLT 16. The smart contract 18 is associated with one of the VolumeDAOs 14 which is set up on the DLT 16. The smart contract 18 is configured for managing the digital contents 10, in particular for adding and outputting the digital contents 10, within the VolumeDAO 14. The smart contract 18 is configured for controlling playback enables for the digital contents 10 within the VolumeDAO 14. The smart contract 18 is configured for controlling an integration of new digital contents 10 into a specific CMS 48 of the VolumeDAO 14. The smart contract 18 has one or more input functions (“write functions”). The smart contract 18 has one or more output functions. A DLT address of the DLT 16 is assigned to the smart contract 18. The smart contract 18 can receive DLT transactions. The smart contract 18 can send DLT response transactions to further DLT addresses of the DLT 16. Many smart contracts 18 of many VolumeDAOs 14 can be set up on the DLT 16.

The CMS 48 has an interface device 22. The interface device 22 is configured for communicating with the DLT 16. The interface device 22 is configured for forming an interface between the DLT 16 and a content playback device 54 of the CMS 48, which can be assigned in particular to a user 32, and/or a content creation device 52 which can be assigned to a further user 12. In principle, it would also be conceivable for the content playback devices 54 and/or the content creation devices 52 to communicate with the DLT 16 directly and independently of interface devices 22. The interface device 22 is permanently assigned to a user 12, 32. The interface device 22 can be embodied, for example, as an electronic tag or as a wearable. The interface device 22 is configured to be carried along with the user 12, 32. The CMS 48 has a localization device 50. The localization device 50 is configured for determining an instantaneous position of the user 12, 32. The localization device 50 is configured for determining the location coordinates at which the user 12, 32 is located. The localization device 50 is identical to the interface device 22. Alternatively, however, a separate embodiment is also conceivable. By way of example, the interface device 22 could receive user localizations from a third-party device, for example from a smartphone assigned to the user 12, 32. The interface device 22 is configured for comparing the determined localizations of the user 12, 32, in particular in real time, with virtual localizations of digital contents 10 within the CMS 48. The digital contents 10 can be embodied as augmented reality objects or as virtual reality objects. The interface device 22 is configured for informing the user 12, 32 of digital contents 10 which are located in a region of the localization of the user 12, 32, for example in a segment 26, 28 in which the user 12, 32 is currently located. Alternatively or additionally, the content playback devices 54 can also be configured for this task. The CMS 48 has the content playback device 52. The content playback device 52 is embodied differently from the localization device 50. The content playback device 52 is embodied differently from the interface device 22. The content playback device 52 is embodied by way of example as a headphone/as VR glasses. The content playback device 52 is configured for outputting the digital contents 10 to the user 12, 32. The localization device 50 can be configured for communicating with one or more anchor stations 82. This communication serves primarily for the localization of the instantaneous position of the user 12, 32, but can also serve for the local transmission of digital contents 10. In this case, the anchor station 82 is configured for locally storing digital contents 10 redundantly to the DLT 16 or as part of the DLT 16.

The CMS 48 has the content creation device 52. The content creation device 52 is embodied differently from the localization device 50. The content creation device 52 is embodied differently from the interface device 22. The content creation device 52 can be embodied identically to the interface device 22. The content creation device 52 can be identical to the content playback device 54. In the exemplary illustration of FIG. 2, however, the content creation device 52 and the content playback device 54 are embodied differently and separately from one another and are assigned in particular to different users 12, 32.

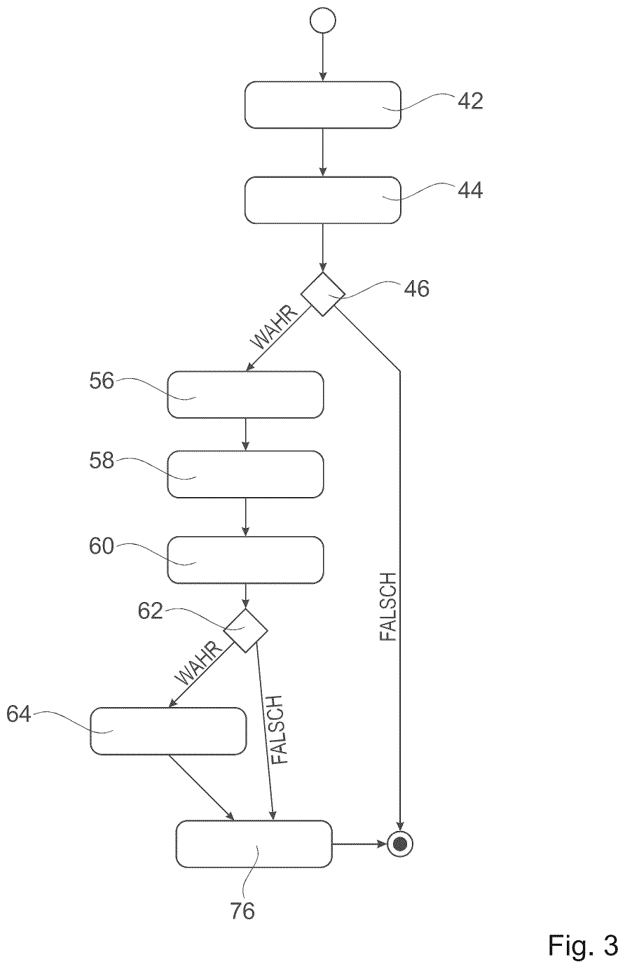

FIG. 3 schematically shows a part of a flow diagram of the CMM. The CMM is embodied as a location-based decentralized CMM. The CMM is configured for managing digital contents 10 within the metaverse 20 linked to a DLT 16. The digital contents 10 are assigned to individual segments 26, 28 in the CMM. In the CMM, VolumeDAOs 14 set up on the DLT 16 are respectively assigned at least to the segments 26, 28 to which digital contents 10 are assigned. The VolumeDAOs 14 of the individual segments 26, 28 are respectively autonomous and independent of one another. In at least one method step 42, the user 12 enters one of the segments 26, 28. In this case, he moves in the real existing space. In at least one further method step 44, the geographical position of the user 12 is determined and/or confirmed. The geographical position of the user 12 is determined via the localization device 50. If the stay of the user 12 in the segment 26, 28 is reliably confirmed, the user 12 receives in a further method step 46 the permission to upload a digital content 10 which is then to be assigned to the segment 26, 28. In at least one method step 56, the user 12 uploads the digital content 10. In this case, the user 12 can place the digital content 10 arbitrarily within the segment 26, 28. In at least one further method step 58, the digital content 10 newly uploaded into/from the segment 26, 28 is received by the DLT 16 or information that a digital content 10 has been uploaded into/from the segment 26, 28 is received by the DLT 16. In the method step 58, upon receiving the uploaded digital content 10 an assignment of the digital content 10 to the respective segment 26, 28 in the virtual space 24 is effected by a recourse to the localization, effected in the method step 44, of the user 12 initiating the upload in the real existing space superimposed by the virtual space 24.

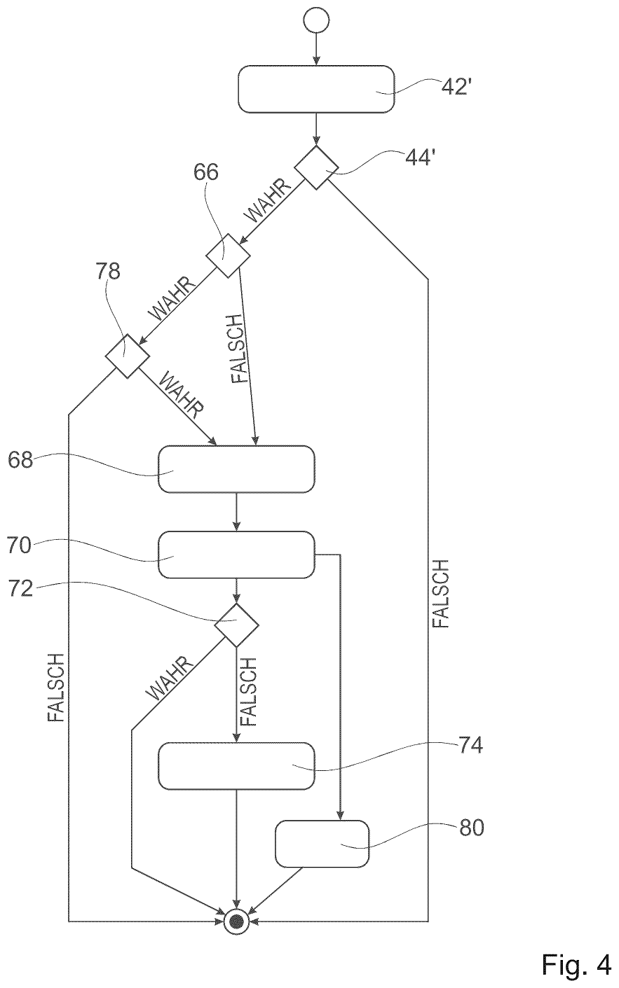

In at least one further method step 60, in response to the upload of the digital content 10 from the segment 26, 28 a Creator Non-Fungible Token (CreatorNFT 30) is generated within the DLT 16. In the method step 60, the digital content 10 is linked to the CreatorNFT 30 on the DLT 16. The CreatorNFT 30 is thus only minted by users 12 who have visited the segment 26, 28 in the real existing space. However, the CreatorNFT 30 can still be transferred freely. In at least one further method step 62, it is checked whether a VolumeDAO 14 assigned to the segment 26, 28 and set up on the DLT 16 already exists. In the method step 62, it is checked whether a CreatorNFT 30 (or a FollowerNFT 34, see FIG. 4) already exists for the segment 26, 28. In at least one method step 64, a new VolumeDAO 14 is created for the segment 26, 28 within the DLT 16, if the check from the method step 62 reveals that until now no VolumeDAO 14 assigned to the segment 26, 28 already exists or that no CreatorNFT 30 (or FollowerNFT 34) assigned to the segment 26, 28 already exists. In at least one further method step 76, the created CreatorNFT 30 is sent to a DLT address of the DLT 16 which is assigned to the user 12 who has uploaded the respective digital content 10. The CreatorNFT 30 forms a Governance Token of the VolumeDAO 14. In subsequent method steps, for each further digital content 10′ uploaded within the segment 26, 28 a respective further CreatorNFT 30′ can then be generated within the DLT 16, which is linked to the respective further digital content 10′ and which likewise forms a Governance Token of the VolumeDAO 14.

FIG. 4 schematically shows a further part of the flow diagram of the CMM. The sequence of the method steps with the reference symbols 42′ and 44′ is similar to the method steps with the reference symbols 42 and 44 already explained in connection with FIG. 3, wherein the user 32 now has no intention of uploading a digital content 10, but rather of merely following a segment 26, 28/a sub-metaverse 38, 40 as follower. If the stay of the user 32 in the segment 26, 28 is reliably confirmed, in a further method step 66 a subsequent status of the user 32 with respect to the segment 26, 28 in which the user 32 is currently located is determined. In this case, it is determined whether the user 32 is already following the segment 26, 28 or not. The subsequent status is alterable for the user 32 in a location-independent manner for each of the segments 26, 28 of the metaverse 20. If it is determined in the method step 66 that the user 32 is not yet following the segment 26, 28, in at least one further method step 78 the user 32 is asked whether he/she wishes to become a follower of the segment 26, 28. If the user 32 confirms this, a registration of the user 32 as a follower of the segment 26, 28 is initiated. In at least one method step 68, the registration of the new follower for the segment 26 is received in the CMS 48. As a result of the registration, the user 32 is assigned to the segment 26, 28 as follower. In at least one further method step 70—assuming the positive proof of the stay of the follower of the segment 26 at a location in the real existing space, which is superimposed on this segment 26, 28 in the virtual space 24—a Follower Non-Fungible Token (FollowerNFT 34) is generated within the DLT 16. The FollowerNFT 34 is thus only minted by users 32 who have visited the segment 26, 28 in the real existing space. However, the FollowerNFT 34 can still be transferred freely.

In at least one further method step 72, it is checked whether a VolumeDAO 14 assigned to the segment 26, 28 and set up on the DLT 16 already exists. In the method step 72, it is checked whether a FollowerNFT 34 or a CreatorNFT 30 already exists for the segment 26, 28. In at least one method step 74, a new VolumeDAO 14 is created for the segment 26, 28 within the DLT 16, if the check from the method step 72 reveals that until now no VolumeDAO 14 assigned to the segment 26, 28 already exists or that no FollowerNFT 34 (or CreatorNFT 30) assigned to the segment 26, 28 already exists. In at least one further method step 80, the created FollowerNFT 34 is sent to a DLT address of the DLT 16 which is assigned to the user 32 who has proved his stay within the segment 26, 28. The FollowerNFT 34 forms a further Governance Token of the VolumeDAO 14. In subsequent method steps, for each new follower who has proved his stay in the segment 26, 28 a further FollowerNFT 34′ is then generated within the DLT 16, which is sent with the respective new follower and which likewise forms a Governance Token of the VolumeDAO 14.

1. A content management method, in particular location-based, preferably decentralized, content management method, at least for managing digital contents within a metaverse linked to a distributed ledger technology (DLT), such as a blockchain or a tangle, wherein a virtual space defined by the metaverse is divided into a number of segments, in particular volume segments, arranged at least one of next to one another and above one another, and wherein digital contents are assigned to individual segments, wherein a decentralized autonomous organization (VolumeDAO) set up on the DLT is assigned to at least one of the segments.

2. The content management method according to claim 1, further comprising the method steps:
receiving a new digital content uploaded into or from one of the segments, in particular by the DLT, or receiving information that a digital content has been uploaded into or from a segment and
checking whether a VolumeDAO assigned to the segment and set up on the DLT already exists and
creating a new VolumeDAO for the segment within the DLT, in the case that no VolumeDAO assigned to the segment already exists.

3. The content management method according to claim 1, wherein the virtual space is superimposed on the real existing space.

4. The content management method according to claim 3, wherein the virtual space at least spans the globe.

5. The content management method according to claim 3, wherein upon receiving the uploaded digital content an assignment of the digital content to the respective segment in the virtual space is effected by a localization of at least one of the user initiating the upload and and/or of the interface device in the real existing space superimposed by the virtual space.

6. The content management method according to claim 1, wherein in response to the upload of the digital content from the segment a Creator Non-Fungible Token (CreatorNFT) is generated within the DLT.

7. The content management method according to claim 6, wherein the digital content is linked to the CreatorNFT.

8. The content management method according to claim 6, wherein the CreatorNFT forms a Governance Token of the VolumeDAO.

9. The content management method according to claim 6, wherein the created CreatorNFT is sent to a DLT address of the DLT which is assigned to a user who has uploaded the respective digital content.

10. The content management method according to claim 6, wherein for each further digital content uploaded within the segment a further CreatorNFT is generated within the DLT, which in particular is linked to the respective further digital content, and which in particular likewise forms a Governance Token of the VolumeDAO.

11. The content management method according to claim 3, wherein the segments, in particular the digital contents assigned to segments, can be searched remotely.

12. The content management method according to claim 1, wherein a user is assigned as follower to at least one of the segments.

13. The content management method according to claim 1, further comprising the method steps:
receiving a registration of a new follower for one of the segments,
checking whether a VolumeDAO assigned to the segment and set up on the DLT already exists and
creating a new VolumeDAO for the segment within the DLT, in the case that no VolumeDAO assigned to the segment already exists.

14. The content management method according to claim 12, wherein the virtual space is superimposed on the real existing space and wherein upon a detection of a stay of a follower of the segment at a location in the real existing space, which is superimposed on this segment in the virtual space, a Follower Non-Fungible Token (FollowerNFT) is generated within the DLT.

15. The content management method according to claim 14, wherein the created FollowerNFT is sent to a DLT address of the DLT which is assigned to the follower who has proved his stay within the segment.

16. The content management method according to claim 15, wherein the FollowerNFT forms an, in particular further, Governance Token of the VolumeDAO.

17. The content management method according to claim 1, wherein a, in particular higher-level, VolumeNon-Fungible Token (VolumeNFT) of the DLT is assigned to each of the segments of the virtual space forming the metaverse, which comprises spatial (real) coordinates which define the respective segment and link the respective segment to the real existing space.

18. The content management method according to claim 17, wherein the VolumeNFT does not form a Governance Token of the VolumeDAO.

19. The content management method according to claim 8, wherein the Governance Token can be transferred, in particular freely, between DLT addresses of the DLT.

20. A content management system, in particular location-based, preferably decentralized, content management system, at least for managing digital contents within a metaverse linked to a distributed ledger technology (DLT), such as a blockchain or a tangle, in particular by means of a content management method according to claim 1, wherein a virtual space defined by the metaverse is divided into a number of segments, in particular volume segments, arranged at least one of next to one another and above one another, and wherein digital contents are assigned to individual segments, wherein a decentralized autonomous organization (VolumeDAO) set up on the DLT is assigned to at least one of the segments.

21. The content management system according to claim 20, comprising a localization device which is configured for determining an instantaneous position of the user via a communication with locally located anchor stations, wherein at least one of the anchor stations is configured to locally store digital contents with local reference, in particular redundantly, and to provide them to the locally present user for retrieval, for example by UWB, Bluetooth, WLAN or the like.

22. A metaverse, in particular of a content management system according to claim 21, further comprising a plurality of sub-metaverses which are each formed by a segment of the virtual space defining the metaverse and which are each managed decentrally by a decentralized autonomous organization (VolumeDAO) set up on a distributed ledger technology (DLT), such as a blockchain or a tangle.

23. A computer program product comprising commands which, when the program is executed by a computer, cause the latter to carry out the steps of the content management method according to claim 1.
